(19) United States
(12) Patent Application Publication
(10) Pub. No.: US 2026/0311436 A1
(43) Pub. Date: Oct. 8, 2026

(54) IMMERSIVE VIDEO CAPTURE OF A PHYSICAL ENVIRONMENT

(71) Applicant: Apple Inc., Cupertino, CA (US)

(72) Inventor: Daniel J. Rubenfield, Mercer Island, WA (US)

(21) Appl. No.: 19/630,065

(22) Filed: Mar. 26, 2026

Related U.S. Application Data
(60) Provisional application No. 63/783,680, filed on Apr. 4, 2025.

(51) Int. Cl. G06T 19/00

(52) U.S. Cl. CPC G06T 19/006

(57) ABSTRACT

A device obtains a video of a physical environment from a camera that is associated with a first field-of-view. The video includes respective representations of a plurality of physical articles that are in the physical environment. The device determines a dynamic virtual overlay for the video based on a second field-of-view that is smaller than the first field-of-view. The dynamic virtual overlay includes a set of virtual objects. The device generates a modified video by overlaying the dynamic virtual overlay onto the video. The modified video includes the set of virtual objects overlaid onto the respective representations of one or more of the plurality of physical articles.

### CROSS-REFERENCE TO RELATED APPLICATIONS

This application claims priority to U.S. Provisional Patent App. No. 63/783,680, filed on April 4, 2025, which is hereby incorporated by reference in its entirety.

### TECHNICAL FIELD

The present disclosure generally relates to immersive video capture of a physical environment.

### BACKGROUND

Some devices include a camera. Devices with cameras can be used to capture a video of a physical environment. Sometimes the physical environment has to be prepared prior to capturing the video. For example, undesirable physical articles in the physical environment have to be removed or concealed so that the undesirable physical articles are not depicted in the captured video.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1E are diagrams of an example environment in accordance with some implementations.

FIG. 2 is a block diagram of a system that generates an immersive video in accordance with some implementations.

FIG. 3 is a flowchart representation of a method of generating an immersive video in accordance with some implementations.

FIG. 4 is a block diagram of a device that generates immersive video in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for capturing an immersive video of a physical environment. In some implementations, a device includes one or more processors and a non-transitory memory. In various implementations, a method includes obtaining a video of a physical environment from a camera that is associated with a first field-of-view. The video includes respective representations of a plurality of physical articles that are in the physical environment. The method includes determining a dynamic virtual overlay for the video based on a second field-of-view that is smaller than the first field-of-view. The dynamic virtual overlay includes a set of virtual objects. The method includes generating a modified video by overlaying the dynamic virtual overlay onto the video. The modified video includes the set of virtual objects overlaid onto the respective representations of one or more of the plurality of physical articles.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Devices that capture immersive video often use wide angle cameras. Wide angle cameras capture portions of a physical environment that may typically not be conditioned for video capture. For example, the physical environment may include physical articles that the user does not want depicted in the video. However, due to the use of wide angle cameras the captured video includes undesirable physical articles that may be outside the field-of-view of a traditional video camera. As such, the captured video may depict undesirable objects.

The present disclosure provides methods, systems, and/or devices for generating immersive video for a physical environment. A device selectively overlays virtual objects onto a camera feed in order to output a video feed that depicts a physical environment with target visual characteristics. The device uses a wide angle camera to capture a video of a physical environment. The video depicts various physical articles that are in the physical environment. The device determines that a visual appearance of at least some of the physical articles depicted in the video is to be modified. As such, the device overlays a set of virtual objects onto a portion of the video. The overlaid virtual objects can mask a particular physical article so that the particular physical article is no longer visible. Alternatively, the overlaid virtual objects can change an appearance of an underlying physical article so that the physical article is more suitable for the captured video. The device outputs a modified video with the virtual objects overlaid onto the captured video.

The device obtains depth data from a depth sensor and utilizes the depth data to determine respective geometries of the virtual objects that are overlaid onto the video. For example, the device uses the depth data to determine dimensions and shapes of the virtual objects so that the virtual objects align with representations of physical articles that the virtual objects are overlaid upon. The depth data is from a depth sensor (e.g., a depth camera).

The device obtains lighting information about the physical environment and uses the lighting information to appropriately cast virtual lights onto the virtual objects so that the virtual objects are indistinguishable from the physical articles depicted in the video. The lighting information is from a light sensor (e.g., an ambient light sensor or a 360 degree camera).

The video of the physical environment is captured from a wide angle camera, for example, a 180 degree camera (e.g., an Advanced Immersive Video (AIV) camera). Alternatively, the video is captured by multiple cameras that collectively provide a relatively wide field of view. For example, the device obtains respective video feeds from two cameras with overlapping fields of view.

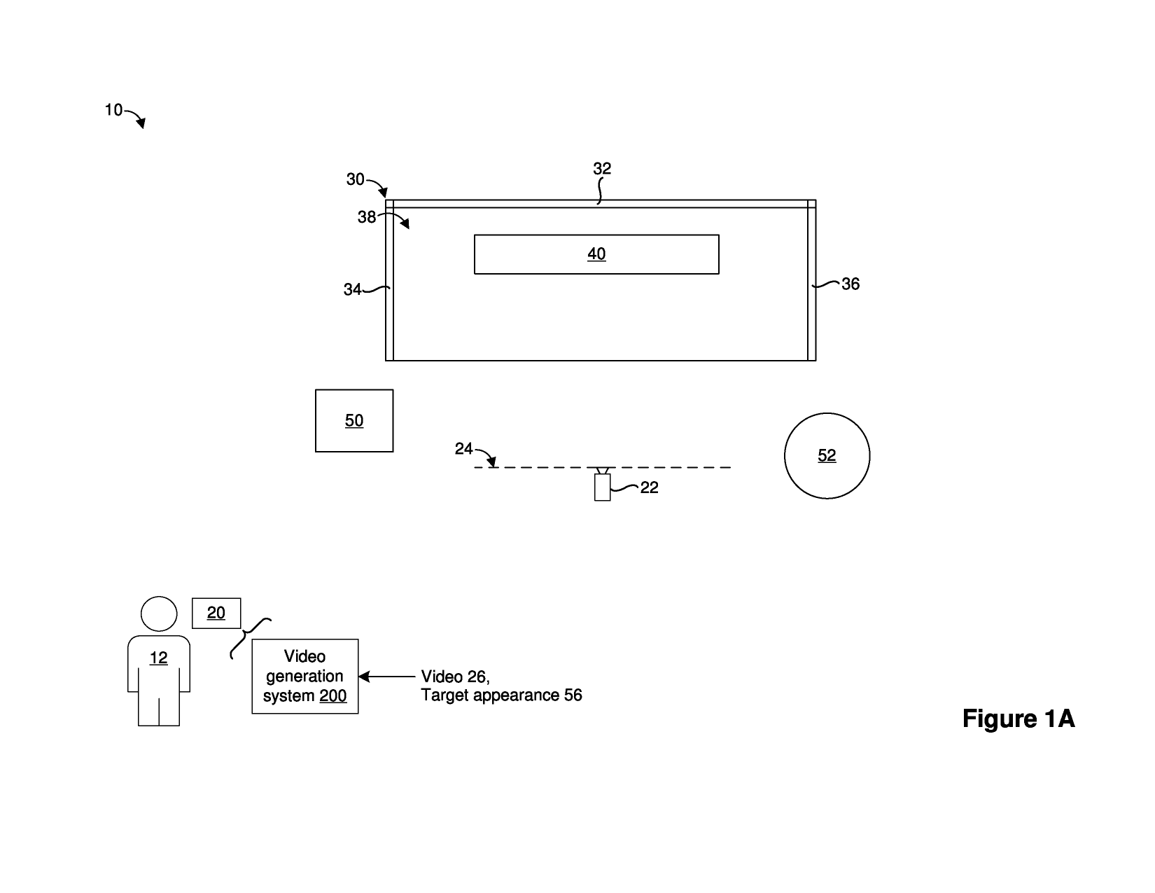

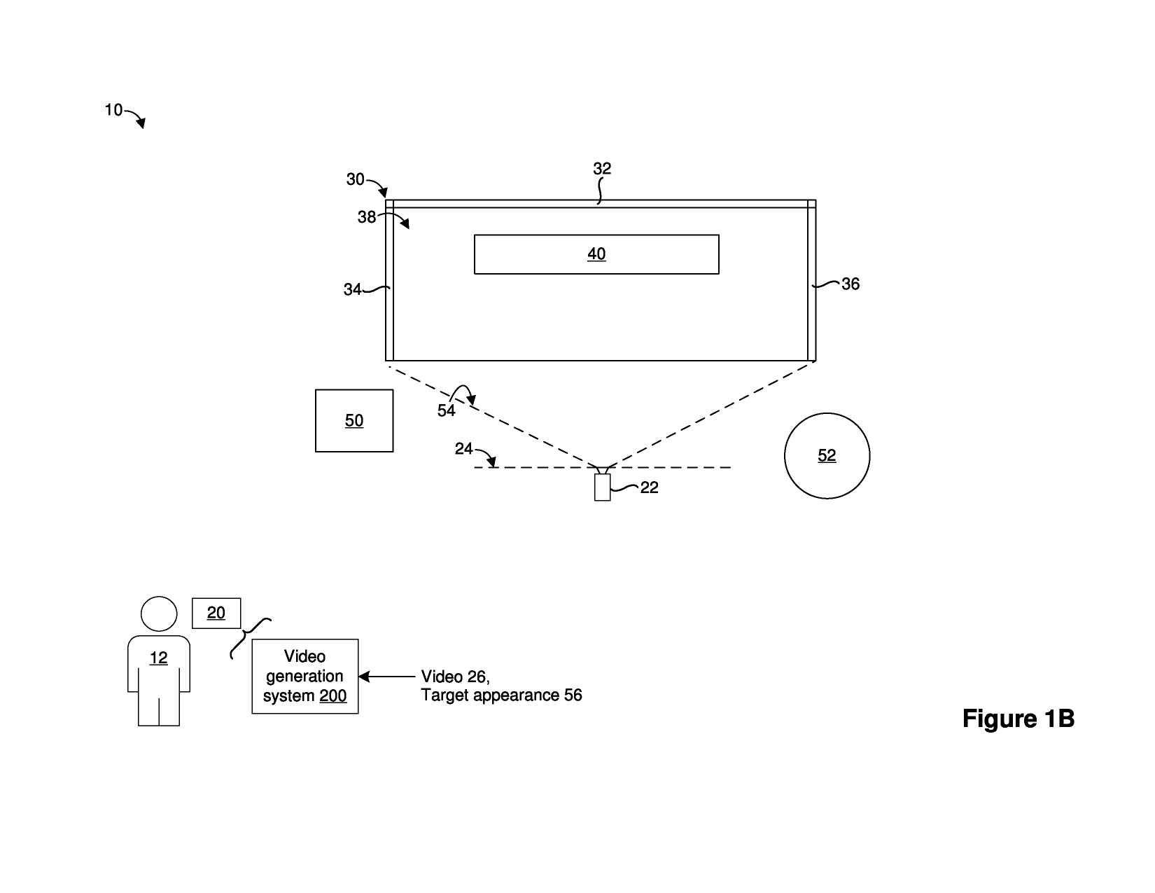

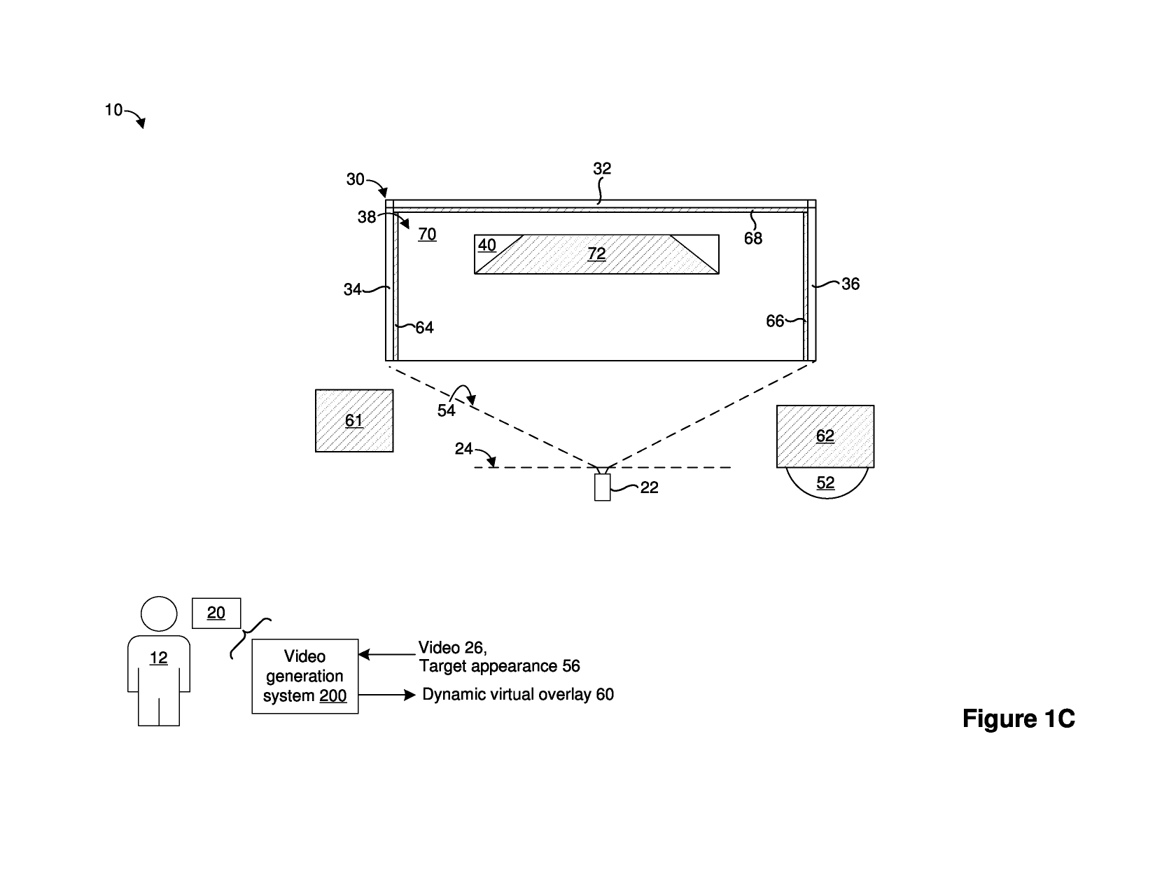

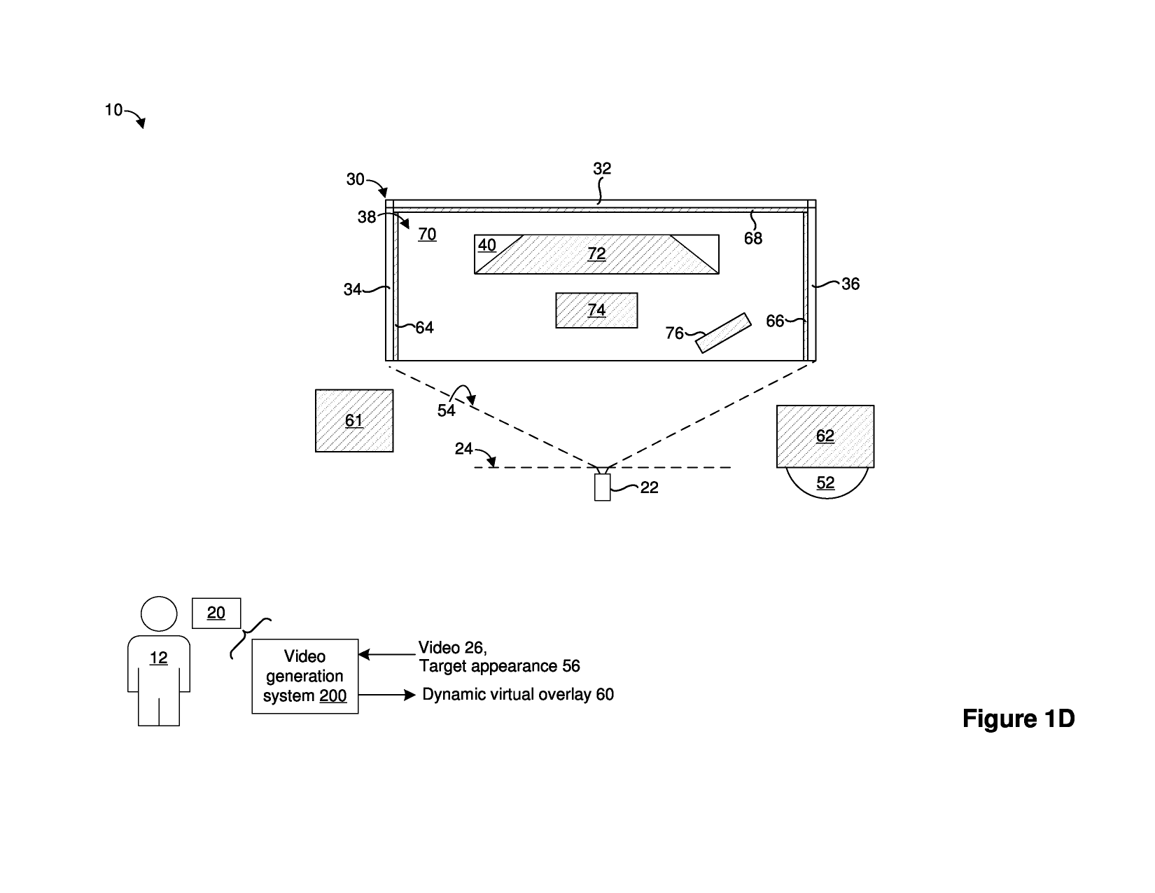

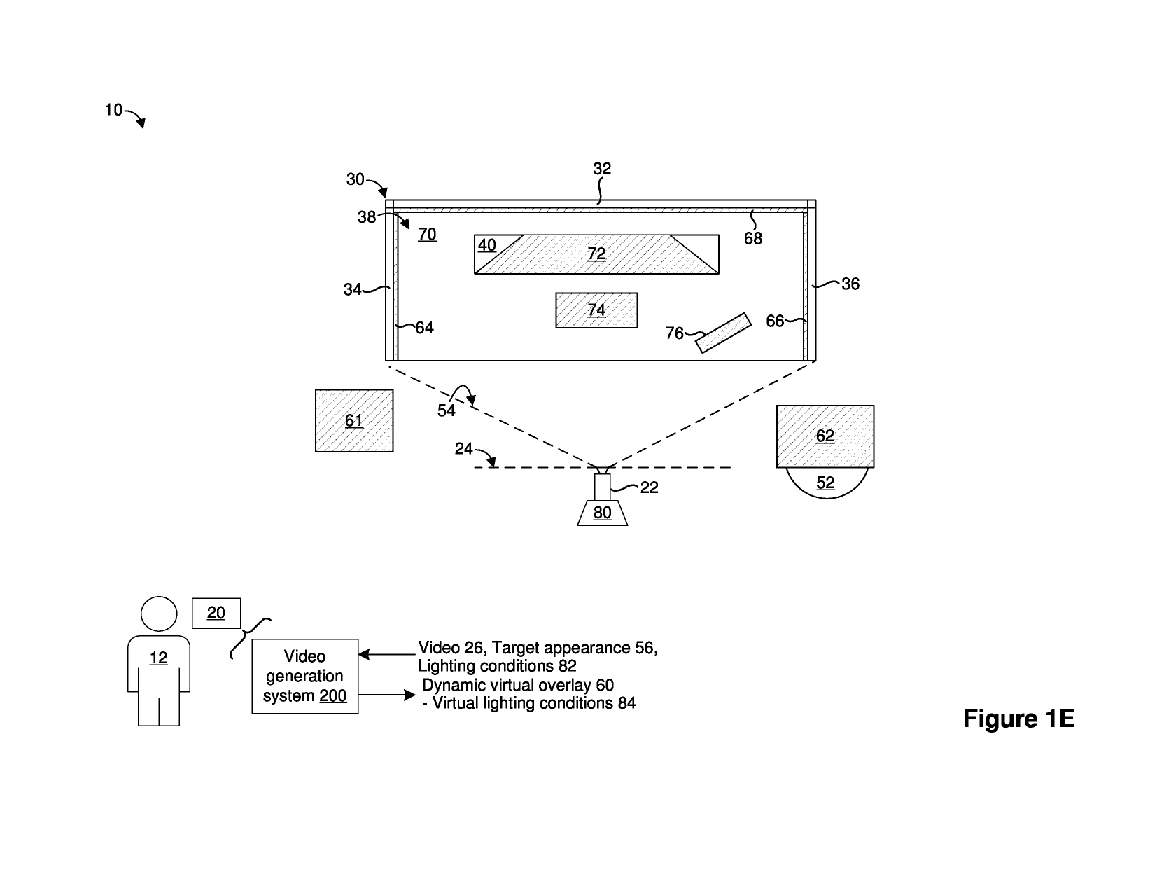

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity), a camera 22 with a first field-of-view 24 (“first FOV 24”, hereinafter for the sake of brevity) to capture a video 26, and a video generation system 200 for generating immersive videos. In some implementations, the video generation system 200 resides at the device 20. Alternatively, in some implementations, the video generation system 200 resides at another device that is in electronic communication with the device 20. For example, the device 20 includes a head-mountable device (HMD) and the video generation system 200 resides at a smartphone that is wirelessly connected with the HMD.

In the example of FIG. 1A, the camera 22 includes an advanced immersive video (AIV) camera that captures immersive video. In some implementations, the camera 22 is a one hundred and eighty degree camera (180 degree camera). As shown in FIG. 1A, the first FOV 24 is one hundred and eighty degrees wide. Since the first FOV 24 is wider than a typical camera that is used for capturing video, the video 26 may include visual representations of undesirable physical articles such as a first undesirable physical object 50 and a second undesirable physical object 52. If the camera 22 had a narrower FOV (e.g., an FOV that is less than one hundred and eighty degrees, for example, an FOV of ninety degrees) then the video 26 may not have included visual representations of the undesirable physical objects 50 and 52. However, due to the relatively wide FOV of the camera 22, the video 26 depicts the undesirable physical objects 50 and 52. In some implementations, the undesirable physical objects 50 and 52 may be fixed or difficult to move, for example, the first undesirable physical object 50 may be equipment that is bolted to a floor of the physical environment 10 and the second undesirable physical object 52 may be a supporting column.

In the example of FIG. 1A, the physical environment 10 includes a filming area 30. The filming area 30 is a portion of the physical environment 10 that is to be filmed (e.g., captured on video). In some implementations, the filming area 30 is a stage. In some implementations, the filming area 30 is moveable. For example, the filming area 30 is a platform on wheels or on a set of tracks (e.g., the filming area 30 is a moving truck or a trolley). In the example of FIG. 1A, the filming area 30 includes a back wall 32, a first side wall 34, a second side wall 36 and a floor 38. In some implementations, the filming area 30 includes a set of physical articles. In the example of FIG. 1A, the filming area 30 includes a physical couch 40 (“couch 40”, hereinafter for the sake of brevity).

In various implementations, the filming area 30 includes unfinished surfaces that are not suitable for video capture. For example, the walls 32, 34 and 36 may be made from plywood and may not have been painted. In some implementations, the video generation system 200 obtains a set of one or more target appearance characteristics 56 (“target appearance 56”, hereinafter for the sake of brevity). The target appearance 56 indicates desired visual characteristics for the filming area 30. For example, the target appearance 56 indicates material finishes and/or colors for the walls 32, 34 and 36. As an example, the target appearance 56 may specify a particular color for the back wall 32, and a particular wallpaper design for the side walls 34 and 36. In some implementations, the target appearance 56 indicates material finishes for physical objects in the filming area 30. For example, the target appearance 56 may specify a particular material and a particular color for the couch 40.

In some implementations, the target appearance 56 includes a directive on how to modify the filming area 30 in order to make the filming area 30 presentable for video capture. In some implementations, the target appearance 56 includes a reference to a previously-captured video (e.g., a previously-filmed TV show or a previously-filmed movie). In such implementations, the video generation system 200 is tasked to modify the video 26 so that the filming area 30 appears similar to a set where the previously-captured video was filmed. In some implementations, the user 12 provides the target appearance 56 as a user input.

Referring to FIG. 1B, the device 20 and/or the video generation system 200 determine a second FOV 54 that is smaller (e.g., narrower) than the first FOV 24. In the example of FIG. 1B, the second FOV 54 captures an entirety of the filming area 30. However, the first and second undesirable physical objects 50 and 52 are outside the second FOV 54. In some implementations, the user 12 specifies the second FOV 54 by providing a user input. For example, the target appearance 56 may indicate the second FOV 54. Alternatively, in some implementations, the device 20 automatically determines the second FOV 54, for example, based on an estimated dimension (e.g., estimated width) of the filming area 30.

Referring to FIG. 1C, in various implementations, the video generation system 200 generates a dynamic virtual overlay 60 based on the video 26 and the target appearance 56. The dynamic virtual overlay 60 includes a set of one or more virtual objects that are overlaid onto the video 26 captured by the camera 22 in order to generate a modified video that is suitable for presentation. In the example of FIG. 1C, the dynamic virtual overlay 60 includes a first virtual masking object 61 that masks (e.g., covers or conceals) the first undesirable physical object 50 shown in FIG. 1B. The dynamic virtual overlay 60 includes a second virtual masking object 62 that masks a portion of the second undesirable physical object 52 that is in the first FOV 24. In various implementations, the dynamic virtual overlay 60 includes virtual objects that mask an undesirable physical object. In some implementations, the video generation system 200 masks physical objects that are blacklisted in the target appearance 56. For example, the target appearance 56 refers to a list of physical objects that are not to appear in the modified video and the video generation system 200 generates the dynamic virtual overlay 60 to include virtual masking objects that mask the blacklisted physical objects.

In the example of FIG. 1C, the dynamic virtual overlay 60 includes a first virtual surface overlay 64 that is overlaid onto the first side wall 34, a second virtual surface overlay 66 that is overlaid onto the second side wall 36, a third virtual surface overlay 68 that is overlaid onto the back wall 32, a fourth virtual surface overlay 70 that is overlaid onto the floor 38, and a virtual couch skin 72 that is overlaid onto the couch 40. The first virtual surface overlay 64 changes a visual appearance of the first side wall 34 based on the target appearance 56. For example, the target appearance 56 specifies a first color for the first side wall 34 and the first virtual surface overlay 64 is a planar virtual object of the first color and the planar virtual object is displayed with a sufficiently high opacity value to mask the first side wall 34. Similarly, the second virtual surface overlay 66 changes an appearance of the second side wall 36 based on the target appearance 56. For example, the target appearance 56 specifies a second color for the second side wall 36 and the second virtual surface overlay 66 is a planar virtual object of the second color and the planar virtual object is displayed with a sufficiently high opacity to conceal an unfinished surface of the second side wall 36. The third virtual surface overlay 68 changes an appearance of the back wall 32 based on the target appearance 56. For example, the target appearance 56 specifies a particular wall paper design for the back wall 32 and the third virtual surface overlay 68 is a planar virtual object with a design that matches the particular wall paper design. The fourth virtual surface overlay 70 changes an appearance of the floor 38 based on a target floor appearance indicated by the target appearance 56. For example, the target appearance 56 specifies that the floor 38 resemble a cherry hardwood floor and the fourth virtual surface overlay 70 is a planar virtual object that makes the floor 38 look like a cherry hardwood floor even when the floor 38 may be unfinished plywood. The virtual couch skin 72 changes an appearance of the couch 40 based on a target couch appearance indicated by the target appearance 56. For example, the virtual couch skin 72 is a virtual object that is shaped like the couch 40 and has the target couch appearance (e.g., a target color or a target pattern) indicated by the target appearance 56.

In various implementations, the dynamic virtual overlay 60 is overlaid onto the video 26 in order to generate a modified video that satisfies the target appearance 56. The modified video is displayed on a display of the device 20 instead of the video 26. The modified video is transmitted to other devices instead of the video 26. Overlaying the dynamic virtual overlay 60 onto video frames of the video 26 allows the user 12 to use the filming area 30 without having to make physical changes to the filming area 30. For example, the user 12 does not have to paint the unfinished walls 32, 34 and 36 of the filming area 30 in order to capture the video 26. As another example, the user 12 does not have to install a green screen on top of the undesirable physical objects 50 and 52 in order to capture the video 26. Reducing the need to make changes to the filming area 30 allows the user 12 to capture the video 26 sooner thereby expediting content production.

In some implementations, the camera 22 is a part of the device 20 and generating the dynamic virtual overlay 60 allows the device 20 to capture video using the camera 22 without having to activate an additional camera with a narrower FOV thereby conserving power and improving an efficiency of the device 20. For example, the device 20 can maintain the additional camera with the narrower FOV in a powered-off state in order to conserve power, capture video using the camera 22 with the wide FOV and overlay the dynamic virtual overlay 60 onto the captured video to make the captured video equivalent to video captured by the additional camera with the narrower FOV.

In various implementations, using the dynamic virtual overlay 60 to change the appearance of the filming area 30 instead of making physical changes to the filming area 30 allows the user 12 to change the appearance of background objects in the video 26 after the video 26 has been captured. For example, if the user 12 wants the walls 32, 34 and 36 to be blue then the user 12 can adjust the target appearance 56 to indicate his/her preference for blue walls. In this example, if the user 12 wants the couch 40 to have different colors during different times of the day, the user 12 can specify the time-based appearances for the couch 40 in the target appearance 56. The dynamic virtual overlay 60 also allows for the video 26 to be modified based on user preferences. For example, if the video 26 is being viewed by a user whose favorite color is pink then the target appearance 56 for the walls 32, 34 and 36 indicates the user’s affinity for pink and the virtual surface overlays 64, 66 and 68 are colored pink. As another example, if the video 26 is being viewed by another user whose favorite color is blue then the target appearance 56 for the walls 32, 34 and 36 indicates the user preference for the color blue and the virtual surface overlays 64, 66 and 68 are colored blue. As such, the dynamic virtual overlay 60 allows for the generation and presentation of personalized content that is tailored to a viewer’s preferences instead of generic content that is not tailored to the viewer’s preferences.

In various implementations, the video generation system 200 determines the dynamic virtual overlay 60 on a frame-by-frame basis. For example, the video generation system 200 obtains a frame of the video 26 and determines the dynamic virtual overlay 60 for the frame based on an analysis of the frame and the target appearance 56. As such, the dynamic virtual overlay 60 can change for each frame in the video 26.

Referring to FIG. 1D, in some implementations, the dynamic virtual overlay 60 includes virtual objects that represent physical articles that are not in the filming area 30. In the example of FIG. 1D, the dynamic virtual overlay 60 includes a virtual table 74 and a virtual TV 76. The virtual table 74 resembles a physical coffee table that is not in the filming area 30. The virtual TV 76 resembles a physical TV that is not in the filming area 30. In some implementations, the target appearance 56 for the filming area 30 specifies physical articles that ought to be in the filming area 30 but are not in the filming area 30. In such implementations, the video generation system 200 generates virtual objects that represent the missing physical articles. In the example of FIG. 1D, the target appearance 56 may specify that the filming area 30 include a physical table and a physical TV to make the filming area 30 look like a living room in a home. Instead of the user 12 having to place a physical table and a physical TV in the filming area 30, the video generation system 200 places the virtual table 74 and the virtual TV 76 in accordance with the target appearance 56.

Referring to FIG. 1E, in some implementations, the physical environment 10 includes a light sensor 80 to detect lighting conditions 82. The video generation system 200 determines virtual lighting conditions 84 based on the lighting conditions 82 detected by the light sensor 80. In some implementations, the virtual lighting conditions 84 are within a degree of similarity to the lighting conditions 82. The video generation system 200 utilizes the virtual lighting conditions 84 to display the virtual objects 74 and 76 so that the virtual objects 74 and 76 appear as real as the physical objects in the filming area 30. For example, the video generation system 200 utilizes the virtual lighting conditions 84 to cast shadows on the virtual objects 74 and 76 so that the virtual table 74 resembles a physical table and the virtual TV 76 resembles a physical TV. In some implementations, the device uses the virtual lighting conditions 84 to determine brightness values for the virtual objects 74 and 76 so that a brightness of the virtual objects 74 and 76 matches a brightness of the couch 40 in the filming area 30. In some implementations, the light sensor 80 includes an ambient light sensor (ALS). In some implementations, the light sensor 80 includes a 360 degree camera.

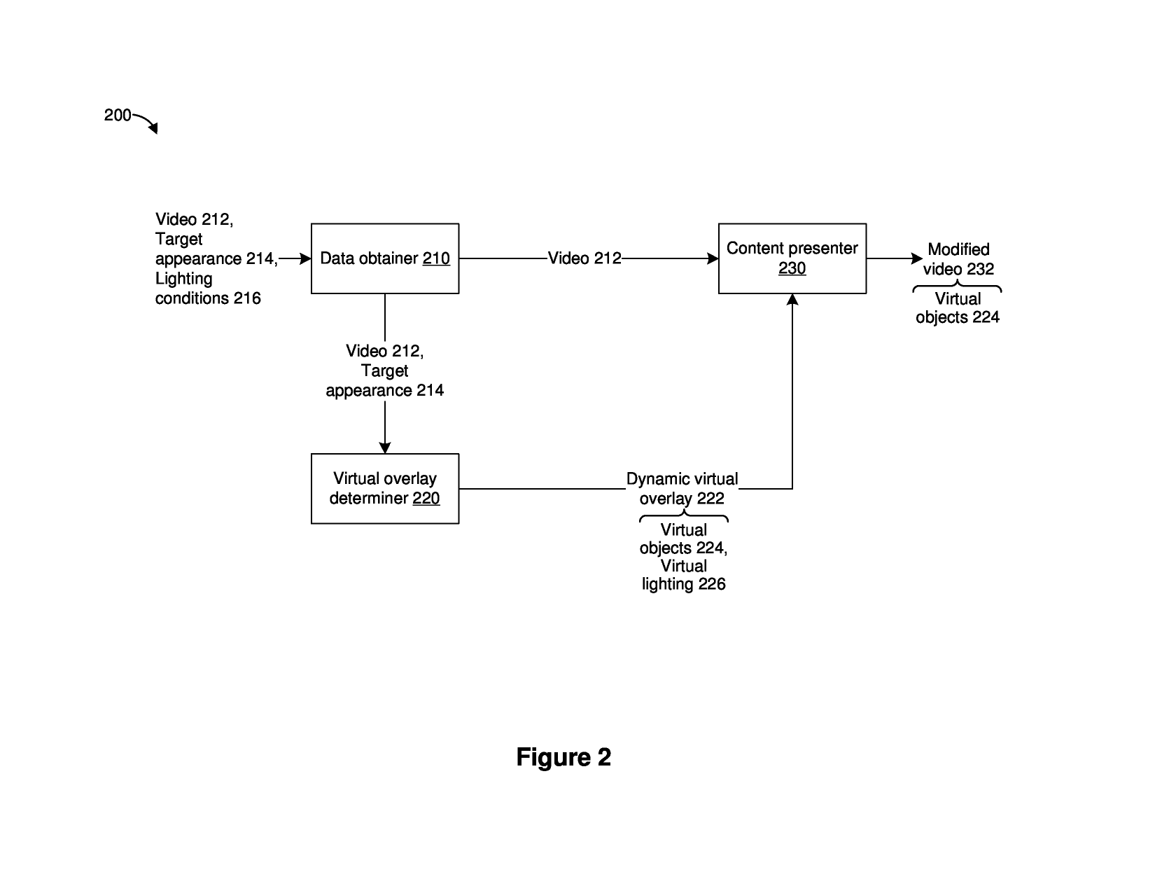

FIG. 2 is a block diagram of the video generation system 200 in accordance with some implementations. In some implementations, the video generation system 200 includes a data obtainer 210, a virtual overlay determiner 220 and a content presenter 230. In various implementations, the data obtainer 210 obtains a video 212 of a physical environment (e.g., the video 26 of the filming area 30 shown in FIG. 1A). In some implementations, the data obtainer 210 receives the video 212 from a wide angle camera, for example, from an advanced immersive camera with a 180 degree FOV. In some implementations, the data obtainer 210 obtains a target appearance 214 for the physical environment that is being filmed (e.g., the target appearance 56 shown in FIGS. 1A and 1B). In some implementations, the target appearance 214 indicates desirable visual characteristics of the physical environment (e.g., desirable colors, textures and lighting levels for walls and physical articles). In some implementations, the data obtainer 210 receives a set of one or more user inputs that specify the target appearance 214. In some implementations, the data obtainer 210 obtains lighting conditions 216 of the physical environment where the video 212 was captured (e.g., the lighting conditions 82 shown in FIG. 1E). In some implementations, the data obtainer 210 receives the lighting conditions 82 from a light sensor (e.g., the light sensor 80 shown in FIG. 1E). In some implementations, the lighting conditions 216 indicate an ambient lighting level of the physical environment, estimated locations of light sources, and intensities and/or colors of lights in the physical environment.

In various implementations, the virtual overlay determiner 220 determines a dynamic virtual overlay 222 (e.g., the dynamic virtual overlay 60 shown in FIG. 1C) for the video 212 based on an analysis of the video 212 and the target appearance 214. The dynamic virtual overlay 222 includes virtual objects 224 that are to be overlaid onto the video 212. The dynamic virtual overlay 222 is associated with virtual lighting 226. For example, the virtual lighting 226 allows the virtual objects 224 to be displayed at an appropriate brightness level to match with a brightness of physical articles in the physical environment. In some implementations, the virtual overlay determiner 220 analyzes the video 212 on a frame-by-frame basis and determines the dynamic virtual overlay 222 on a frame-by-frame basis.

In various implementations, the content presenter 230 generates a modified video 232 by overlaying the dynamic virtual overlay 222 onto the video 212. The modified video 232 satisfies a set of presentation criteria specified in the target appearance 214. Overlaying the dynamic virtual overlay 222 onto the video 212 reduces the need to physically prepare a physical environment where the video 212 was captured in order to make the physical environment suitable for video capture. Since the dynamic virtual overlay 222 is overlaid onto the video 212, the virtual objects 224 are a part of the modified video 232. In some implementations, the virtual objects 224 appear as a separate layer in the modified video 232. A viewer viewing the modified video 232 may be able to turn off the layer corresponding to the virtual objects 224 in order to view the video 212.

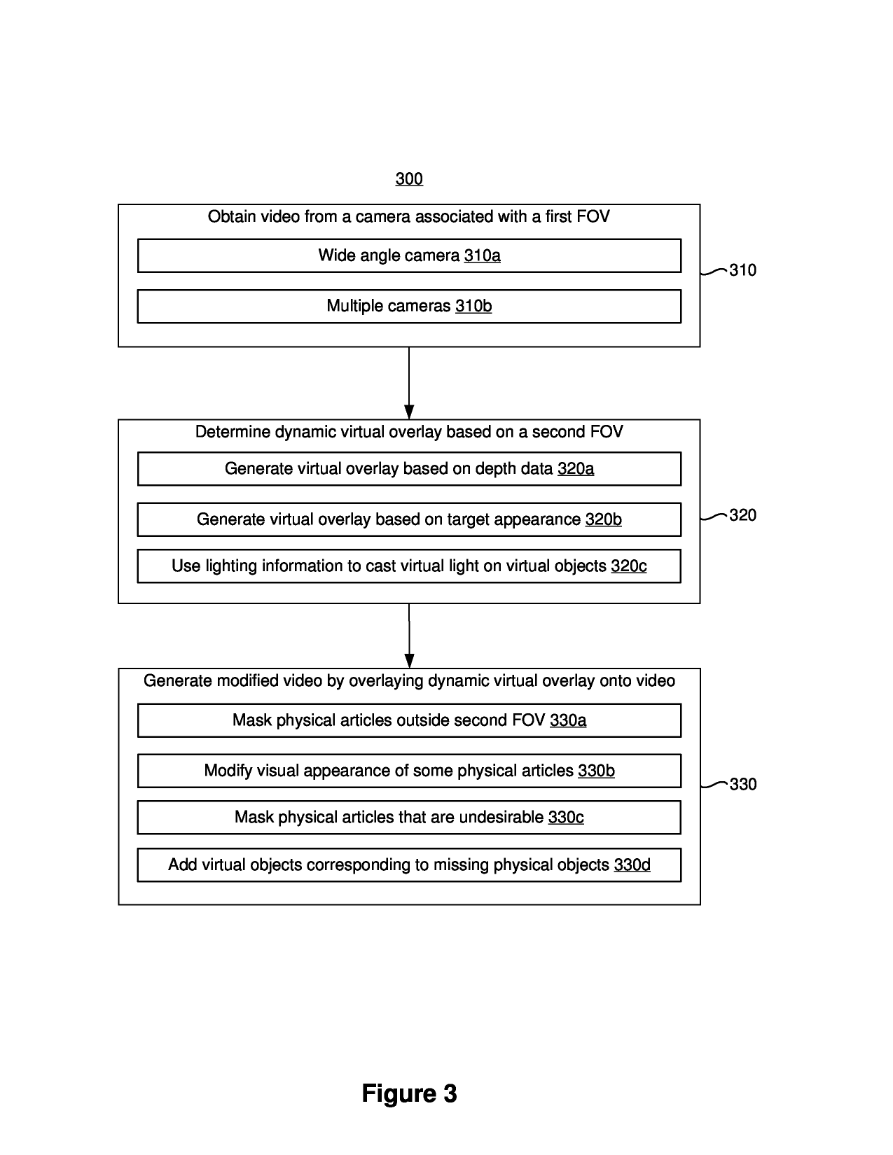

FIG. 3 is a flowchart representation of a method 300 for generating an immersive video. In various implementations, the method 300 is performed by a device including a display, a non-transitory memory and one or more processors coupled with the display and the non-transitory memory (e.g., the device 20 shown in FIGS. 1A-1E and/or the video generation system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in some implementations, the method 300 includes obtaining a video of a physical environment from a camera that is associated with a first field-of-view. The video includes respective representations of a plurality of physical articles that are in the physical environment. For example, as shown in FIG. 1A, the device 20 obtains the video 26 captured by the camera 22. As represented by block 310a, in some implementations, the camera includes a wide-angle camera. For example, referring to FIG. 1A, the first FOV 24 is greater than a threshold angle. In some implementations, the camera includes an advanced immersive video (AIV) camera. In some implementations, the camera includes a 180 degree camera. For example, referring to FIG. 1A, the first FOV 24 is 180 degrees.

As represented by block 310b, in some implementations, the camera includes a plurality of cameras that capture respective videos and the video is a combination of the respective videos captured by the plurality of cameras. As an example, the device obtains a first video from a first camera with a first FOV and a second video from a second camera with a second FOV. In this example, the device combines the first video and the second video to form a merged video with a merged FOV that is greater than the first FOV and the second FOV.

As represented by block 320, in some implementations, the method 300 includes determining a dynamic virtual overlay for the video based on a second field-of-view that is smaller than the first field-of-view. The dynamic virtual overlay includes a set of virtual objects. For example, as shown in FIG. 1C, the device 20 generates the dynamic virtual overlay 60 for the video 26 based on the second FOV 54 that is smaller than the first FOV 24.

As represented by block 320a, in some implementations, determining the dynamic virtual overlay includes generating the set of virtual objects based on depth data corresponding to the physical environment. For example, the device determines dimensions and shapes of physical articles, and generates the virtual objects to match the dimensions and shapes of the physical articles so that the virtual objects provide suitable coverage when the virtual objects are overlaid onto corresponding physical articles. As an example, referring to FIGS. 1B and 1C, the device 20 uses depth data to determine a shape and dimensions of the first undesirable physical object 50 and generates the first virtual masking object 61 based on the shape and dimensions of the first undesirable physical object 50 that the first virtual masking object 61 is to mask.

As represented by block 320b, in some implementations, determining the dynamic virtual overlay includes generating the set of virtual objects based on a target appearance for the physical environment (e.g., based on the target appearance 56 shown in FIG. 1A and/or the target appearance 214 shown in FIG. 2). In some implementations, a user input specifies how the physical environment is to appear. As an example, a user input specifies which physical articles are to be visible and which physical articles are not to be visible (e.g., the user input specifies that the undesirable physical objects 50 and 52 shown in FIG. 1A are not to be seen in the video). As another example, the user input specifies whether certain physical articles are to appear with a different color (e.g., the user input specifies colors for the walls 32, 34 and 36 shown in FIG. 1A). In some implementations, a user input designates the second FOV as a primary FOV and a remainder of the first FOV as the secondary FOV. For example, the user input indicates that all objects that are outside a subset of the captured FOV are to be masked.

As represented by block 320c, in some implementations, determining the dynamic virtual overlay includes generating the set of virtual objects based on lighting information associated with the physical environment. For example, referring to FIG. 1E, the device 20 determines virtual lighting conditions 84 based on lighting conditions 82 and the device 20 adjusts visual characteristics of the virtual objects in the dynamic virtual overlay 60 based on the virtual lighting conditions 84. In some implementations, the device obtains the lighting information from a light sensor such as an ambient light sensor or from a 360 degree camera by applying methods, devices and/or systems associated with image-based lighting (IBL). In some implementations, the device adjusts a visual characteristic (e.g., a brightness, a contrast and/or a hue) of the virtual objects based on the lighting information of the physical environment so that the virtual objects appear more realistic (e.g., so that the virtual objects are visually indistinguishable from physical objects depicted in the video).

As represented by block 330, in some implementations, the method 300 includes generating a modified video by overlaying the dynamic virtual overlay onto the video. The modified video includes the set of virtual objects overlaid onto the respective representations of one or more of the plurality of physical articles. For example, as shown in FIG. 2, the content presenter 230 generates the modified video 232 by overlaying the dynamic virtual overlay 222 onto the video 212 on a frame-by-frame basis.

As represented by block 330a, in some implementations, the set of virtual objects mask the respective representations of a subset of the plurality of physical articles that are outside the second field-of-view. For example, as shown in FIG. 1C, the first virtual masking object 61 masks the first undesirable physical object 50 and the second virtual masking object 62 masks the second undesirable physical object 52.

As represented by block 330b, in some implementations, the set of virtual objects modify a visual appearance of at least some of the plurality of physical articles. For example, referring to FIG. 1C, the first virtual surface overlay 64 modifies a visual appearance of the first side wall 34, the second virtual surface overlay 66 modifies a visual appearance of the second side wall 36 and the third visual surface overlay 68 modifies a visual appearance of the back wall 32. In some implementations, modifying the visual appearance of a physical article includes providing an appearance of changing a color, changing a texture and/or changing a brightness of the physical article.

As represented by block 330c, in some implementations, the plurality of physical articles includes a first physical article that is to be removed from the physical environment and the set of virtual objects includes a first virtual object that is overlaid onto a representation of the first physical article in order to obscure the first physical article in order to provide an appearance that the first physical article is not in the physical environment. For example, as shown in FIG. 1C the first virtual masking object 61 masks (e.g., obscures, conceals or hides) the first undesirable physical object 50 in order to provide an appearance that the first undesirable physical object 50 is not in the physical environment 10. In some implementations, the first virtual object represents a second physical article.

As represented by block 330d, in some implementations, the plurality of physical articles does not include a specified physical article and the set of virtual objects includes a virtual object that represents the specified physical article in order to provide an appearance that the specified physical article is located within the physical environment. For example, as shown in FIG. 1D, the device 20 displays the virtual table 74 and the virtual TV 76 when the filming area 30 does not include a physical table and a physical TV and the target appearance 56 specifies that the filming area 30 include a physical table and a physical TV.

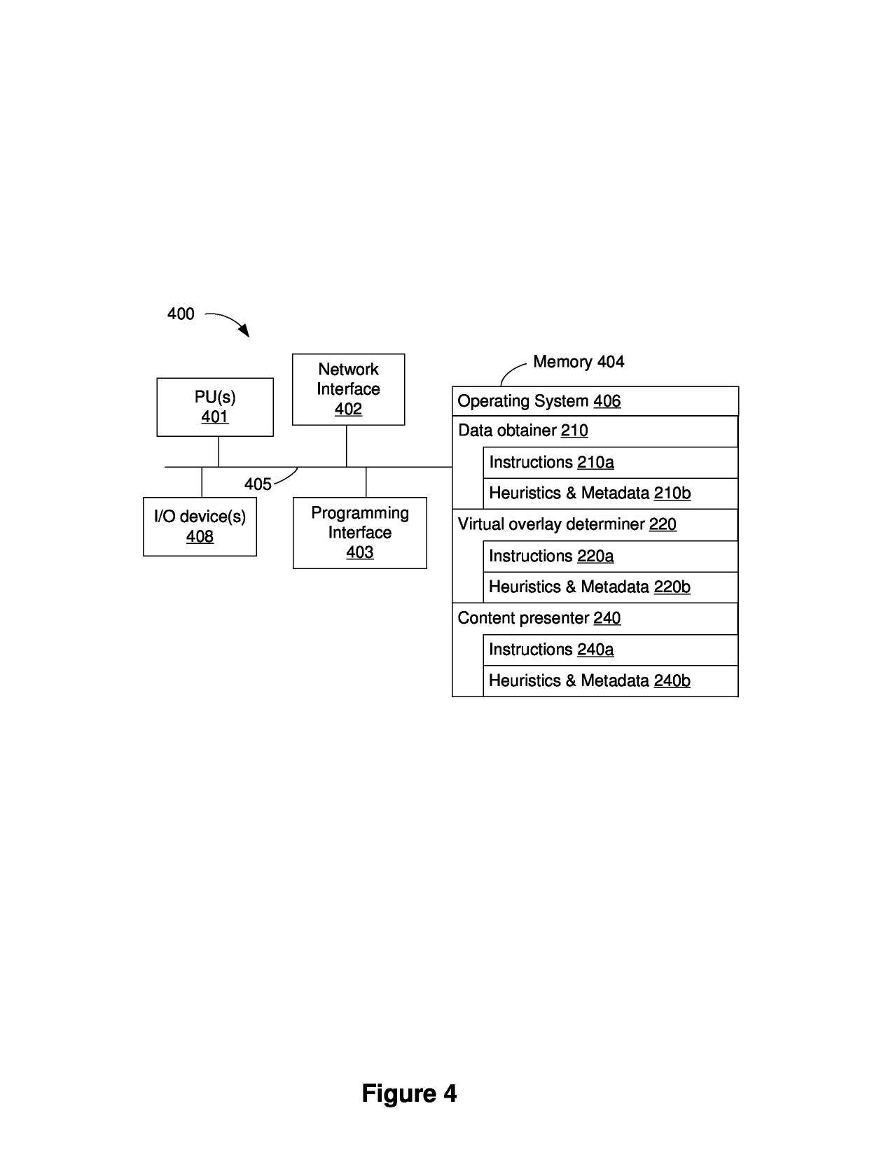

FIG. 4 is a block diagram of a device 400 in accordance with some implementations. In some implementations, the device 400 implements the device 20 shown in FIGS. 1A-2 and/or the video generation system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the virtual overlay determiner 220 and the content presenter 240. In various implementations, the device 400 performs the method 300 shown in FIG. 3.

In some implementations, the data obtainer 210 includes instructions 210a, and heuristics and metadata 210b for obtaining data (e.g., the video 212, the target appearance 214 and the lighting conditions 216 shown in FIG. 2). In some implementations, the data obtainer 210 performs at least some of the operation(s) represented by block 310 in FIG. 3.

In some implementations, the virtual overlay determiner 220 includes instructions 220a, and heuristics and metadata 220b for determining a dynamic virtual overlay that is to be overlaid onto the video (e.g., the dynamic virtual overlay 60 shown in FIG. 1C and/or the dynamic virtual overlay 222 shown in FIG. 2). In some implementations, the virtual overlay determiner 220 performs at least some of the operation(s) represented by block 320 in FIG. 3.

In some implementations, the content presenter 240 includes instructions 240a, and heuristics and metadata 240b for overlaying the dynamic virtual overlay onto the video in order to generate a modified video (e.g., the modified video 232 shown in FIG. 2). In some implementations, the content presenter 240 performs at least some of the operation(s) represented by block 330 in FIG. 3.

In some implementations, the one or more I/O devices 408 include a set of one or more cameras for capturing video. For example, the one or more I/O devices 408 include a camera for capturing the video 26 shown in FIG. 1A. In some implementations, the one or more I/O devices 408 include a light sensor for capturing lighting conditions (e.g., an ambient light sensor (ALS) for capturing ambient light data and/or a 360 degree camera that is used for IBL). In some implementations, the one or more I/O devices 408 receive user inputs (e.g., the target appearance 56 shown in FIG. 1A).

In various implementations, the one or more I/O devices 408 include a video pass-through display which displays at least a portion of a physical environment surrounding the device 400 as an image captured by the camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

In some implementations, there are multiple cameras set up to capture a scene. For example, there may be three cameras set up to capture 180+ degrees of a physical environment. However, there may be a person in the FOV of one of the cameras that is not meant to be in the final video. For example, there may be a sound technical in the FOV of one of the three cameras holding a microphone adjacent to an actor. In this example, the device reconstructs the synthetic video feed to mask out the sound technician. The device can use data feeds (e.g., image streams) from the cameras in 3D space, wide FOV data, locations of the cameras and the sound technician to generate a dynamic virtual overlay that includes a masking element to dynamically mask the sound technician.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a non-transitory memory and one or more processors:
obtaining a video of a physical environment from a camera that is associated with a first field-of-view, wherein the video includes respective representations of a plurality of physical articles that are in the physical environment;
determining a dynamic virtual overlay for the video based on a second field-of-view that is smaller than the first field-of-view, wherein the dynamic virtual overlay includes a set of virtual objects; and
generating a modified video by overlaying the dynamic virtual overlay onto the video, wherein the modified video includes the set of virtual objects overlaid onto the respective representations of one or more of the plurality of physical articles.

2. The method of claim 1, wherein determining the dynamic virtual overlay comprises generating the set of virtual objects based on depth data corresponding to the physical environment.

3. The method of claim 1, wherein determining the dynamic virtual overlay comprises generating the set of virtual objects based on a target appearance for the physical environment.

4. The method of claim 1, wherein determining the dynamic virtual overlay comprises generating the set of virtual objects based on lighting information associated with the physical environment.

5. The method of claim 1, wherein the set of virtual objects mask the respective representations of a subset of the plurality of physical articles that are outside the second field-of-view.

6. The method of claim 1, wherein the set of virtual objects modifies a visual appearance of at least some of the plurality of physical articles.

7. The method of claim 1, wherein the plurality of physical articles includes a first physical article that is to be removed from the physical environment and the set of virtual objects includes a first virtual object that is overlaid onto a representation of the first physical article in order to obscure the first physical article and provide an appearance that the first physical article is not in the physical environment.

8. The method of claim 1, wherein the plurality of physical articles does not include a specified physical article and the set of virtual objects includes a virtual object that represents the specified physical article in order to provide an appearance that the specified physical article is located within the physical environment.

9. The method of claim 1, wherein the camera includes a wide-angle camera.

10. The method of claim 1, wherein the camera includes an advanced immersive video (AIV) camera.

11. The method of claim 1, wherein the camera includes a 180 degree camera.

12. The method of claim 1, wherein the camera includes a plurality of cameras that capture respective videos and the video is a combination of the respective videos captured by the plurality of cameras.

13. A device comprising:
a camera;
one or more processors;
a non-transitory memory; and
one or more programs stored in the non-transitory memory, which, when executed by the one or more processors, cause the device to:
obtain a video of a physical environment from a camera that is associated with a first field-of-view, wherein the video includes respective representations of a plurality of physical articles that are in the physical environment;
determine a dynamic virtual overlay for the video based on a second field-of-view that is smaller than the first field-of-view, wherein the dynamic virtual overlay includes a set of virtual objects; and
generate a modified video by overlaying the dynamic virtual overlay onto the video, wherein the modified video includes the set of virtual objects overlaid onto the respective representations of one or more of the plurality of physical articles.

14. The device of claim 13, wherein determining the dynamic virtual overlay comprises generating the set of virtual objects based on depth data corresponding to the physical environment.

15. The device of claim 13, wherein determining the dynamic virtual overlay comprises generating the set of virtual objects based on lighting information associated with the physical environment.

16. The device of claim 13, wherein the set of virtual objects masks the respective representations of a subset of the plurality of physical articles that are outside the second field-of-view.

17. The device of claim 13, wherein the set of virtual objects modifies a visual appearance of at least some of the plurality of physical articles.

18. The device of claim 13, wherein the plurality of physical articles includes a first physical article that is to be removed from the physical environment and the set of virtual objects includes a first virtual object that is overlaid onto a representation of the first physical article in order to obscure the first physical article and provide an appearance that the first physical article is not in the physical environment.

19. The device of claim 13, wherein the plurality of physical articles does not include a specified physical article and the set of virtual objects includes a virtual object that represents the specified physical article in order to provide an appearance that the specified physical article is located within the physical environment.

20. A non-transitory memory storing one or more programs, which, when executed by one or more processors of a device coupled with a camera cause the device to:
obtain a video of a physical environment from a camera that is associated with a first field-of-view, wherein the video includes respective representations of a plurality of physical articles that are in the physical environment;
determine a dynamic virtual overlay for the video based on a second field-of-view that is smaller than the first field-of-view, wherein the dynamic virtual overlay includes a set of virtual objects; and
generate a modified video by overlaying the dynamic virtual overlay onto the video, wherein the modified video includes the set of virtual objects overlaid onto the respective representations of one or more of the plurality of physical articles.
